(19) United States
(12) Patent Application Publication
(10) Pub. No.: US 2025/0391158 A1
(43) Pub. Date: Dec. 25, 2025

(54) GENERATION METHOD, NON-TRANSITORY COMPUTER-READABLE RECORDING MEDIUM, AND INFORMATION PROCESSING DEVICE

(71) Applicant: Fujitsu Limited, Kawasaki-shi (JP)

(72) Inventor: Sosuke YAMAO, Kawasaki (JP)

(73) Assignee: Fujitsu Limited, Kawasaki-shi (JP)

(21) Appl. No.: 19/312,560

(22) Filed: Aug. 28, 2025

Related U.S. Application Data
(63) Continuation of application No. PCT/JP2023/008329, filed on Mar. 6, 2023.

(51) Int. Cl. G06V 10/774; G06T 17/00; G06T 19/20; G06V 10/98; G06V 20/64; G06V 40/10

(52) U.S. Cl. CPC G06V 10/7747; G06T 17/00; G06T 19/20; G06V 10/98; G06V 20/64; G06V 40/10; G06T 2219/2004

(57) ABSTRACT

A generation method includes specifying a first distribution of postures of a person and a second distribution of positions or orientations or both of a camera based on a plurality of sample images in which the postures of the person and the positions and orientations of the camera that captures the person are different from each other augmenting the postures of the person in a range included in the first distribution augmenting the positions or orientations or both of the camera in a range included in the second distribution and generating an augmented image based on the augmented positions or orientations or both of the camera and the augmented postures of the person, by using a processor.

### CROSS-REFERENCE TO RELATED APPLICATION

This application is a continuation application of International Application No. PCT/JP2023/008329, filed on Mar. 6, 2023, the entire contents of which are incorporated herein by reference.

### FIELD

The embodiment discussed herein is related to a generation method and the like.

BACKGROUND

There is known a technique of estimating a 3D human body model of a person appearing in an image captured by a monocular camera using a training model (statistical human body model) such as Human Mesh Recovery (HMR).

FIG. 18 is a diagram illustrating an example of an estimation result by the HMR. For example, when an image 1-1 is input to the HMR, an estimation result 1-2 is obtained. In the estimation result 1-2, estimated are 3D human body models 2a, 2b, 2c, 2d, 2e, and 2f corresponding to people 1a, 1b, 1c, 1d, 1e,and 1f included in the image 1-1.

A technique of estimating a 3D human body model of a person from an image is expected to be applied to various fields in which motion of the person is important such as Virtual Reality (VR), Augmented Reality (AR), healthcare, sports, telepresence, and Human-Computer Interaction (HCI).

Herein, in many HMR methods, it is assumed that training data and test data follow the same distribution, but actually, there is a gap between standard training data and test data in a practical application.

FIG. 19 is a diagram illustrating an example of a gap between a training data set and a test data set. For example, comparing a training data set 2-1 with a test data set 2-2, there are gaps in distributions of human body postures, positions of a camera (viewpoints of the camera), appearances, and occlusions, and a domain shift is caused. Thus, when a 3D human body model of a person included in the test data set 2-2 is estimated by using a training model trained by the training data set 2-1, accuracy may be lowered.

Due to this, there is a demand for eliminating the domain shift that is present between training data set and test data in a target application.

For example, as means for eliminating the domain shift, first means and second means are exemplified.

The first means is a technique of training a training model by collecting new 3D teacher data of a target application (Target domain). To collect 3D teacher data used for training, a special measurement system and environment such as Motion Capture (MoCap) is used, so that it is difficult to implement approach by the first means in many practical applications.

The second means is a technique of adapting a pre-trained training model to a domain by preparing a sample image of a target application (Target domain). In the second means, it is noted that a sample image of the target application and 2D skeletal information of a person in the sample image can be relatively easily obtained.

In the second means, a training model that is pre-trained by 3D teacher data of a Source domain is fine-tuned to be adapted to a Target domain so that a 3D human body model that fits a 2D skeleton is inferred in each sample image of the Target domain.

For example, as a conventional technique related to the second means, SPIN and DAPA are known.

The SPIN is a training method that combines regression-based HMR and optimized HMR. In the SPIN, an image captured by a monocular camera is input to a training model to estimate a 3D human body model (regression-based HMR). Additionally, in the SPIN, the 3D human body model is fitted to a 2D skeleton in the image to estimate the 3D human body model (optimized HMR). In the SPIN, the training model is fine-tuned to reduce an error between an estimation result of the regression-based HMR and an estimation result of the optimized HMR.

The DAPA is domain adaptation of 3D posture distribution using 3D posture perturbation and image augmentation. In the DAPA, for each sample image, a 3D posture of the 3D human body model estimated by a training model during domain adaptation is perturbed to a rare posture in a 3D posture space of the Source domain. Additionally, in the DAPA, the sample image is augmented by depicting the perturbed 3D human body model on the sample image. In the DAPA, augmentation of the sample image and fine-tuning of the training model are repeatedly performed under the constraint that an inference result in the sample image is fitted to the 2D skeleton. The related technologies are described, for example, in:
Wei Jiang, Kwang Moo Yi, Golnoosh Samei, Oncel Tuzel, Anurag Ranjan, “NeuMan, Neural Human Radiance Field from a Single Video,” ECCV 2022;
Mohsen Gholami, Bastian Wandt, Helge Rhodin, Rabab Ward, Z. Jane Wang, AdaptPose: Cross-Dataset Adaptation for 3D Human Pose Estimation by Learnable Motion Generation, CVPR 2022;
Nikos Kolotouros, Georgios Pavlakos, Michael J. Black, Kostas Daniilidis, “Learning to Reconstruct 3D Human Pose and Shape via Model-fitting in the Loop,” ICCV 2019; and
Zhenzhen Weng, Kuan-Chieh Wang, Angjoo Kanazawa, Serena Yeung, “Domain Adaptive 3D Pose Augmentation for In-the-wild Human Mesh Recovery,” 3DV 2022.

The second means described above is adapted to data of the condition that a posture of a person included in a sample image and the position of the camera co-occur, or data in which only the posture of the person is perturbed using such a co-occurrence condition as a starting point. For this reason, an effect of domain adaptation is limited in terms of comprehensiveness for the Target domain.

FIG. 20 is a diagram (1) for explaining problems in the conventional technique. It is assumed that a vertical axis of a graph G1 in FIG. 20 is an axis corresponding to a position distribution of a camera, and a horizontal axis is an axis corresponding to a posture distribution of a person. A distribution of Target domain data is assumed to be a distribution 10. Sample images to be given are assumed to be images 5, 6, 7, and 8. Distributions of data that can be adapted by the SPIN using the images 5 to 8 are distributions 5a, 6a, 7a, and 8a. Distributions of data that can be adapted by the DAPA using the images 5 to 8 are 5b, 6b, 7b, and 8b.

Comparing the distribution 10 of the Target domain data with the distributions 5a to 8a and 5b to 8b, a range of the distribution 10 is not covered by the distributions 5a to 8a and 5b to 8b, so that the effect of domain adaptation is limited.

FIG. 21 is a diagram (2) for explaining problems in the conventional technique. For example, if domain adaptation of HMR is performed by using a sample image 9a that is captured at a position of a certain camera by the second means, estimation accuracy for the 3D human body model in a test image 9b at a position of the camera different from the position of the camera in the sample image is lowered at an operation phase.

That is, in the conventional technique, it is not possible to train a training model that can correctly recognize a 3D human body model of a person appearing in an image that is captured at a position of a camera different from the position of the camera corresponding to the sample image.

### SUMMARY

According to an aspect of an embodiment, a generation method includes specifying a first distribution of postures of a person and a second distribution of positions or orientations or both of a camera based on a plurality of sample images in which the postures of the person and the positions and orientations of the camera that captures the person are different from each other augmenting the postures of the person in a range included in the first distribution augmenting the positions or orientations or both of the camera in a range included in the second distribution and generating an augmented image based on the augmented positions or orientations or both of the camera and the augmented postures of the person, by using a processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a distribution of data that can be adapted by an information processing device according to an embodiment;

FIG. 2 is a diagram illustrating an example of a plurality of sample images corresponding to each scene;

FIG. 3 is a diagram illustrating an example of pseudo teacher data;

FIG. 4 is a diagram illustrating an example of a 3D human body model;

FIG. 5 is a diagram illustrating an example of a human body NeRF;

FIG. 6 is a diagram illustrating an example of a scene NeRF;

FIG. 7 is a diagram illustrating an example of a distribution of positions and orientations of a camera characteristic of a Target domain;

FIG. 8 is a diagram illustrating an example of a distribution of postures of a person characteristic of the Target domain;

FIG. 9 is a diagram for explaining processing of augmenting positions and orientations of the camera;

FIG. 10 is a diagram for explaining processing of augmenting postures of the person;

FIG. 11 is a functional block diagram illustrating a configuration of the information processing device according to the present embodiment;

FIG. 12 is a diagram illustrating an example of a data structure of pseudo teacher data;

FIG. 13 is a diagram illustrating an example of a data structure of augmented teacher data;

FIG. 14 is a diagram illustrating an example of a relation between the pseudo teacher data and the augmented teacher data;

FIG. 15 is a diagram illustrating an example of a synthetic image generated by an augmentation processing unit;

FIG. 16 is a flowchart illustrating a processing procedure of the information processing device according to the present embodiment;

FIG. 17 is a diagram illustrating an example of a hardware configuration of a computer that implements the same function as that of the information processing device in the embodiment;

FIG. 18 is a diagram illustrating an example of an estimation result by HMR;

FIG. 19 is a diagram illustrating an example of a gap between a training data set and a test data set;

FIG. 20 is a diagram (1) for explaining problems in a conventional technique; and

FIG. 21 is a diagram (2) for explaining problems in the conventional technique.

### DESCRIPTION OF EMBODIMENT

Preferred embodiments of the present invention will be explained with reference to accompanying drawings. The invention is not limited to the embodiment.

An information processing device according to the present embodiment specifies a distribution of positions and orientations of a camera characteristic of a Target domain and a distribution of postures of a person characteristic of the Target domain based on a plurality of sample images belonging to the Target domain. The information processing device augments the positions and orientations of the camera and the postures of the person to be included in the distribution of the camera positions characteristic of the Target domain and the distribution of the postures of the person characteristic of the Target domain, and generates augmented data (augmented teacher data) using an augmented result.

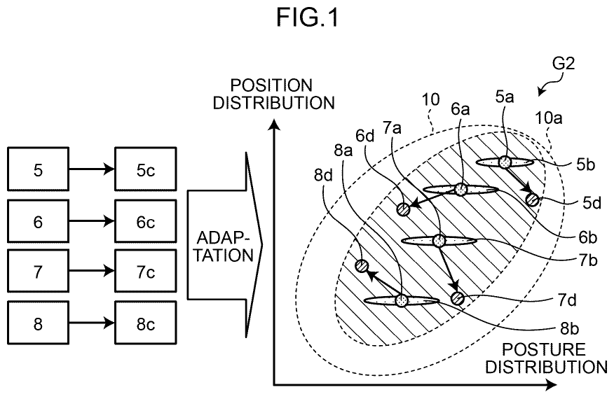

FIG. 1 is a diagram illustrating an example of a distribution of data that can be adapted by the information processing device according to the present embodiment. A vertical axis of a graph G2 in FIG. 1 is assumed to be an axis corresponding to the distribution of the positions and orientations of the camera, and a horizontal axis is assumed to be an axis corresponding to the posture distribution of the person. A distribution of Target domain data is assumed to be a distribution 10. The information processing device generates pieces of augmented teacher data 5c, 6c, 7c, and 8c by performing data augmentation described above on sample images 5, 6, 7, and 8. For example, distributions on the graph G2 corresponding to the pieces of augmented teacher data 5c, 6c, 7c, and 8c are distributions 5d, 6d, 7d, and 8d, respectively.

The information processing device augments the positions and orientations of the camera to be included in the distribution of the positions and orientations of the camera characteristic of the Target domain. Due to this, with respect to the distribution 10 of the Target domain data, it is possible to cover a range 10a larger than a range that can be covered by the second means described as the conventional technique. That is, it is possible to generate augmented teacher data for training a training model (machine training model) that can correctly recognize a posture of a person appearing in an image that is captured at a position and orientation of a camera different from the position and orientation of the camera corresponding to the sample image.

For example, the information processing device according to the present embodiment performs preprocessing, processing of specifying a distribution characteristic of the Target domain, processing of generating augmented teacher data, and processing of training a training model.

First, the following describes the preprocessing performed by the information processing device. The information processing device acquires a plurality of sample images belonging to the Target domain, which are a plurality of sample images for each scene. For example, the scene indicates a place where a person is photographed. A partial scene (described later) is a scene obtained by further dividing a series of identical scenes.

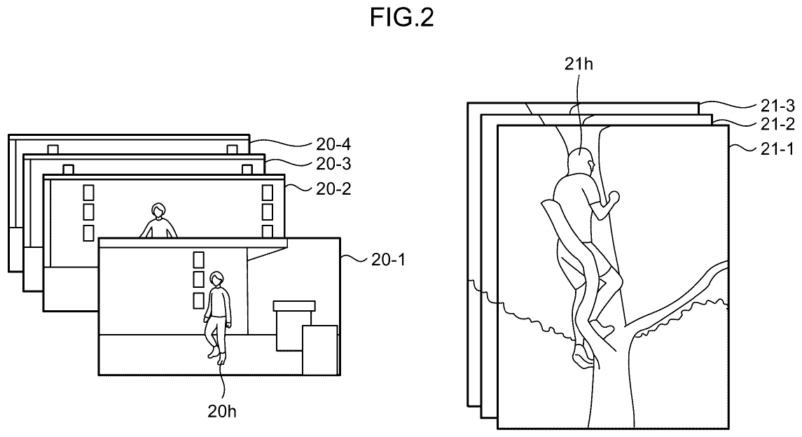

FIG. 2 is a diagram illustrating an example of a plurality of sample images corresponding to each scene. Sample images 20-1, 20-2, 20-3, and 20-4 are sample images of a certain one scene (in front of a house), and there is a certain person 20h therein. Sample images 21-1, 21-2, and 21-3 are sample images of a certain one scene (forest), and there is a certain person 21h therein.

To the sample images 20-1 to 20-4, frame numbers are set in ascending order. To the sample images 20-1 to 20-4, the same scene label for uniquely identifying the scene is set.

To the sample images 21-1 to 21-3, frame numbers are set in ascending order. To the sample images 21-1 to 21-3, the same scene label for uniquely identifying the scene is set.

Although not illustrated in the drawings, the information processing device may also acquire a plurality of sample images corresponding to a scene different from that of the sample images 20-1 to 20-4 and 21-1 to 21-3 described above with reference to FIG. 2.

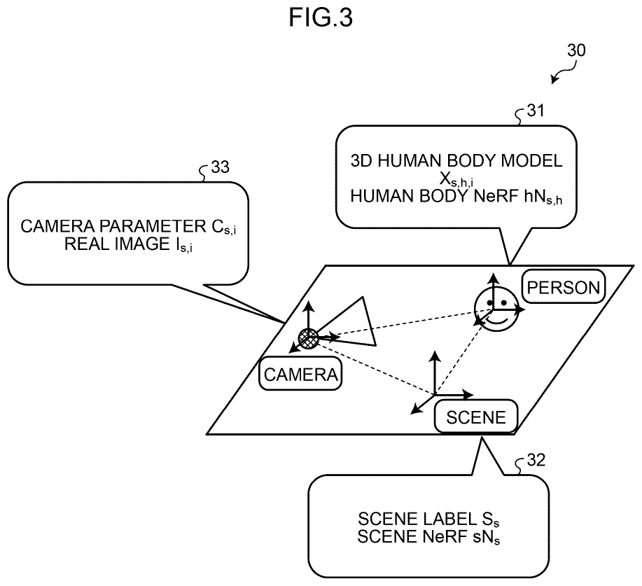

The information processing device generates pseudo teacher data for each scene by analyzing the sample images described above with reference to FIG. 2. FIG. 3 is a diagram illustrating an example of the pseudo teacher data. For example, pseudo teacher data 30 includes person information 31 about a person, scene information 32 about a scene, and camera information 33 about a camera.

The person information 31 includes a 3D human body model X_{s,h,i} and a human body Neural Radiance Fields (NeRF) hN_{s,h}. The subscript “s” indicates a partial scene, the subscript “h” indicates a person, and the subscript “i” indicates a frame number. The partial scene “s” as the subscript used in the person information 31 (the scene information 32, the camera information 33) is a scene obtained by further dividing a series of scenes corresponding to the scene label.

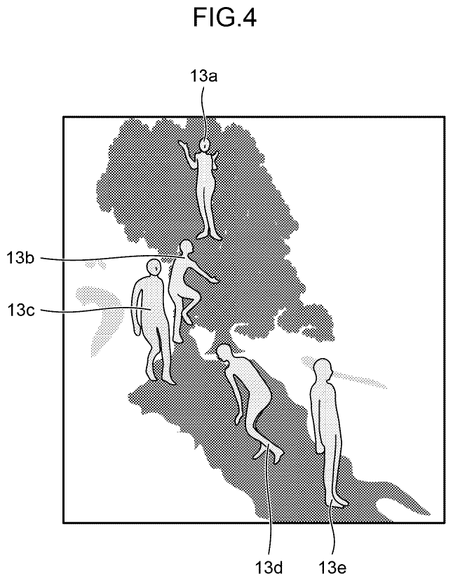

The 3D human body model X_{s,h,i} is a 3D human body model of the person “h” obtained by inputting the sample image of the partial scene “s” and the frame number “i” to the HMR and the like. FIG. 4 is a diagram illustrating an example of the 3D human body model. For example, 3D human body models 13a, 13b, 13c, 13d, and 13e illustrated in FIG. 4 are generated from the sample images 21-1 to 21-3 and the like described above with reference to FIG. 2, respectively. One 3D human body model is generated for one person included in one sample image.

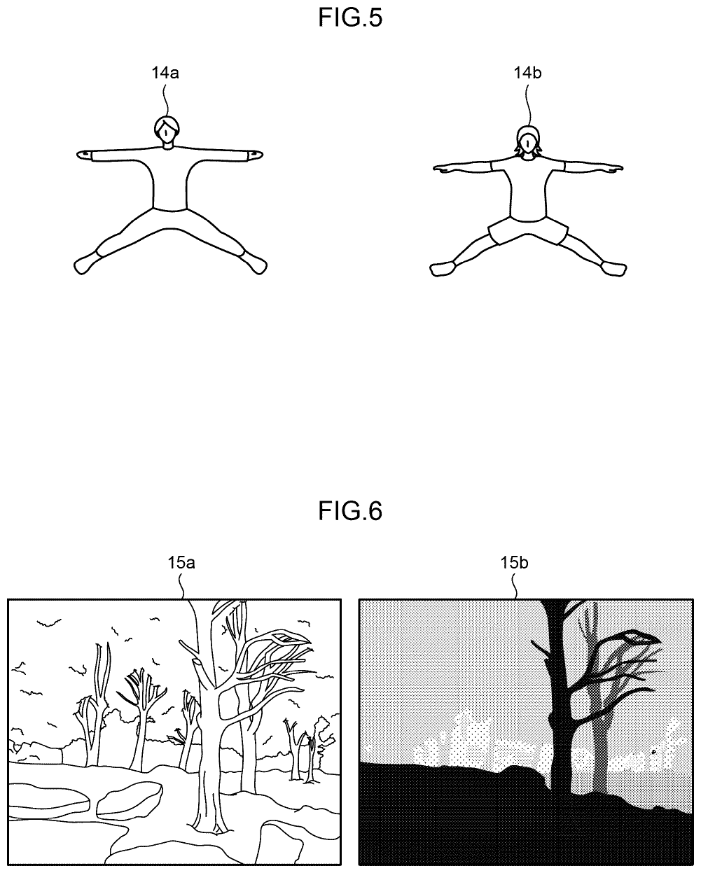

The human body NeRF hN_{s,h} is an NeRF of the person “h” that is estimated based on the sample images of the partial scene “s” and frame numbers “i to i+n”. FIG. 5 is a diagram illustrating an example of the human body NeRF. For example, a human body NeRF 14ain FIG. 5 is an NeRF of the person 20h that is estimated from the sample images 20-1 to 20-4 in FIG. 2. The human body NeRF 14b is an NeRF of the person 21h that is estimated from the sample images 21-1 to 21-3 in FIG. 2.

Return to the description of FIG. 3. The scene information 32 includes a scene label Sₛ and a scene NeRF SNₛ. The subscript “s” indicates the partial scene described above. The scene label Sₛ is a scene label S of the partial scene “s”. The scene NeRF sNₛ is an NeRF of the partial scene “s” that is estimated based on the sample images of the frame numbers “i to i+n”. FIG. 6 is a diagram illustrating an example of the scene NeRF. Scene NeRFs 15a and 15b are NeRFs of a series of scenes estimated from the sample images 21-1 to 21-3. For example, the scene NeRF 15a is an RGB synthetic image at a certain camera position, and the scene NeRF 15b is a depth synthetic image corresponding to the RGB synthetic image.

Return to the description of FIG. 3. The camera information 33 includes a camera parameter C_{s,i} and a real image I_{s,i}. The description of the subscript “s” and the subscript “i” is the same as described above.

The camera parameter C_{s,i} indicates an external parameter of the camera that captured the sample image of the partial scene “s” and the frame number “i”. The camera parameter C_{s,i} is information corresponding to the position and an orientation of the camera. The real image I_{s, i} indicates the sample image of the partial scene “s” and the frame number “i”.

As described above, the information processing device performs the preprocessing described above, and generates a plurality of pieces of pseudo teacher data for each scene from the sample images for each scene.

Subsequently, the following describes processing of specifying a distribution characteristic of the Target domain performed by the information processing device. The information processing device specifies a distribution of “camera parameters C_{s,i}” set for the pieces of pseudo teacher data as a distribution of the positions and orientations of the camera characteristic of the Target domain. The information processing device also specifies a distribution of “3D human body models X_{s,h,i}” set for the pieces of pseudo teacher data as a distribution of the postures of the person characteristic of the Target domain.

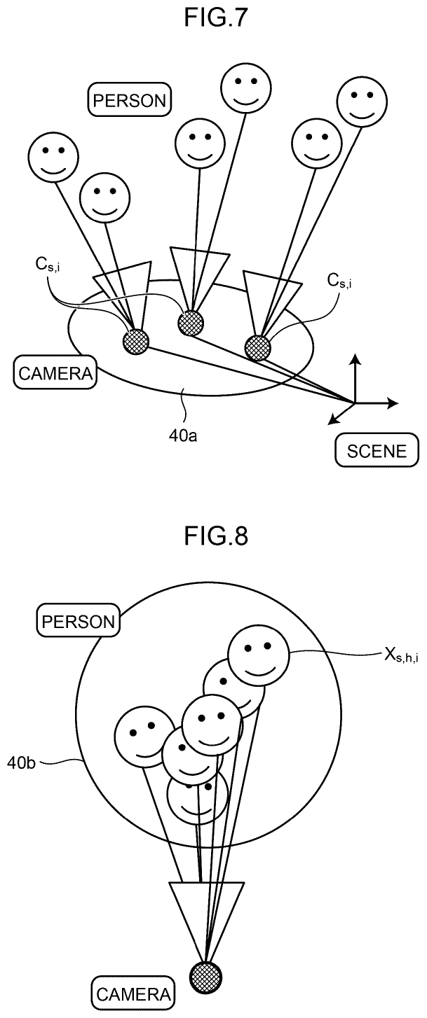

FIG. 7 is a diagram illustrating an example of the distribution of the positions and orientations of the camera characteristic of the Target domain. A distribution 40a illustrated in FIG. 7 indicates a distribution of the positions and orientations of the camera in each scene (each partial scene). The distribution 40a corresponds to a distribution of the “camera parameters C_{s,i}” in the pieces of pseudo teacher data.

FIG. 8 is a diagram illustrating an example of the distribution of the postures of the person characteristic of the Target domain. A distribution 40b illustrated in FIG. 8 indicates the distribution of the postures of the person viewed from the camera. The distribution 40b corresponds to a distribution of the “3D human body models X_{s,h,i}” in the pieces of pseudo teacher data. It can be also said that the distribution of the postures of the person is a distribution of relative positional relations between the camera position and the position of the person (how the person is captured).

For example, the information processing device performs machine training of (trains) a domain discriminator using a Gaussian Mixture Model (GMM) and a Variational Auto Encoder (VAE). The information processing device inputs the “camera parameters C_{s,i}” of the pieces of pseudo teacher data to a first domain discriminator to learn the distribution 40a illustrated in FIG. 7. The information processing device inputs the “3D human body models X_{s,h,i}” of the pieces of pseudo teacher data to a second domain discriminator to learn the distribution 40b illustrated in FIG. 8.

By using the domain discriminator (the first domain discriminator, the second domain discriminator) described above, it is possible to determine whether the augmented teacher data obtained by augmenting the positions and orientations of the camera and the postures of the person is augmented in a range characteristic of the Target domain.

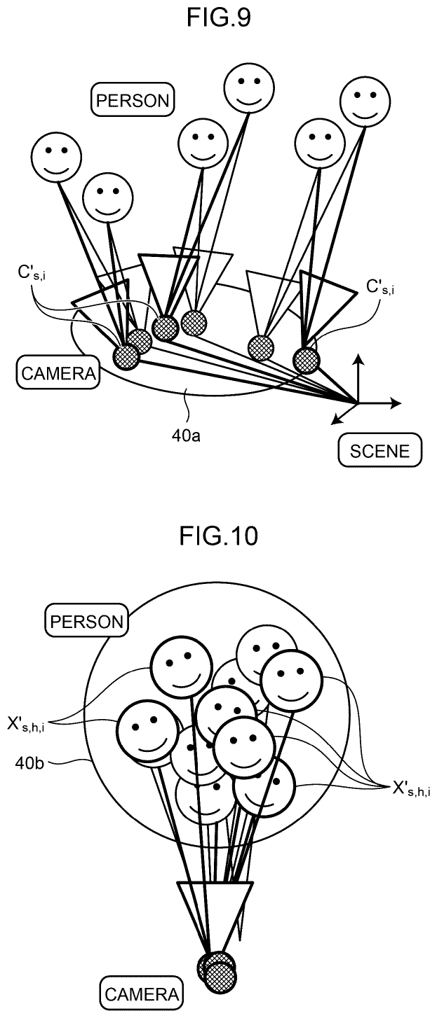

Subsequently, the following describes processing of generating augmented teacher data performed by the information processing device. FIG. 9 is a diagram for explaining processing of augmenting the positions and orientations of the camera (camera parameters C′_{s,i}). The information processing device generates the “camera parameter C′_{s,i}” as included in the distribution 40a. For example, the information processing device uses a first augmenter that randomly changes the “camera parameter C_{s,i}”.

The information processing device generates augmented “camera parameter C′_{s,i}” by inputting the “camera parameter C_{s,i}” to the first augmenter. The information processing device inputs the generated “camera parameter C′_{s,i}” to the first domain discriminator, and calculates a score of Target domain likeness. The information processing device employs the generated “camera parameter C′_{s,i}” when the score of Target domain likeness is equal to or larger than a threshold.

FIG. 10 is a diagram for explaining processing of augmenting the postures of the person (3D human body models X_{s,h,i}). The information processing device generates the “3D human body model X′_{s,h,i}” as included in the distribution 40b. For example, the information processing device uses a second augmenter that randomly changes the “3D human body model X_{s,h,i}”.

The information processing device generates the augmented “3D human body model X′_{s,h,i}” by inputting the “3D human body model X_{s,h,i}” to the second augmenter. The information processing device inputs the generated “3D human body model X′_{s,h,i}” to the second domain discriminator, and calculates the score of Target domain likeness. The information processing device employs the generated “3D human body model X′_{s,h,i}” when the score of Target domain likeness is equal to or larger than the threshold.

The information processing device generates a “synthetic image I′_{s,i}” based on the “camera parameter C′_{s,i}” and the “3D human body model X′_{s,h,i}” generated by the processing described above. For example, the information processing device adjusts the posture of the human body NeRF hN_{s,h} based on the “3D human body model X′_{s,h,i}”. The information processing device generates the “synthetic image I′_{s,i}” by capturing information obtained by synthesizing the adjusted human body NeRF hN_{s,h} and the scene NeRF sNₛ by the camera of the camera parameter C′_{s,i}.

The information processing device generates augmented teacher data having the “synthetic image I′_{s,i}” as input data and the “3D human body model X′_{s,h,i}” as a correct answer label. The information processing device generates a plurality of pieces of the augmented teacher data by repeatedly performing the processing described above.

As described above, the information processing device performs the preprocessing, the processing of specifying the distribution characteristic of the Target domain, and the processing of generating the augmented teacher data. Due to this, it is possible to generate the augmented teacher data for training the training model that can correctly recognize the 3D human body model of the person from the image of the Target domain.

Subsequently, the following describes processing of training the training model performed by the information processing device. The information processing device performs training using pseudo teacher data and training using augmented teacher data.

The following describes processing in a case in which the information processing device trains the training model as a training target by using the pseudo teacher data. The information processing device inputs the “real image I_{s,i}” of the pseudo teacher data to the training model, and calculates a recognition error between an output of the training model and the “3D human body model X_{s,h,i}” of the pseudo teacher data. The information processing device updates parameters of the training model so that the recognition error is reduced based on an error back-propagation method.

The information processing device updates the parameters of the training model by repeatedly performing the processing described above based on the pieces of pseudo teacher data.

The following describes processing in a case in which the information processing device trains the training model as a training target by using the augmented teacher data. The information processing device inputs the “synthetic image I′_{s,i}” of the augmented teacher data to the training model, and calculates a recognition error between an output of the training model and the “3D human body model X′_{s,h,i}” of the augmented teacher data. The information processing device updates the parameters of the training model so that the recognition error is reduced based on the error back-propagation method.

The information processing device updates the parameters of the training model by repeatedly performing the processing described above based on the pieces of augmented teacher data. When training the training model based on the pieces of augmented teacher data, the information processing device may update parameters of the first augmenter and the second augmenter described above so that the recognition error output from the training model falls within a certain range.

For example, a total loss Lₜₒₜₐₗ of the first augmenter and the second augmenter is defined by an expression (1). L_{view} included in the expression (1) is a loss related to the position and orientation of the camera, and defined by an expression (2). Herein, the loss related to the position and orientation of the camera is indicated, but any one of a loss of the position of the camera and a loss of the orientation of the camera may be used.

$${ℒ}_{total} = {ℒ}_{view} + {λ}_{hard} {ℒ}_{hard} \qquad ( 1 )$$

$${ℒ}_{view} = {λ}_{c \_ pos} {ℒ}_{c \_ pos} + {λ}_{h \_ pos} {ℒ}_{h \_ pos} + {λ}_{h\_rot} {ℒ}_{h \_ rot} \qquad ( 2 )$$

In the expression (2), L_{c_pos} is a loss related to likelihood of the position and orientation of the camera in a world coordinate system. Lₕ₋ₚₒₛ is a loss related to likelihood of the position of the person in a camera coordinate system. L_{h_rot} is a loss related to likelihood of the orientation of the person in the camera coordinate system. For example, L_{c_pos} corresponds to the camera parameter C_{s,i}. L_{h_rot} and L_{h_rot} are calculated based on the camera parameter C_{s,i} and the 3D human body model X_{s,h, i}. λ_{c_pos}, λ_{h_pos}, and λ_{h_rot} included in the expression (2) are coefficients set in advance.

λ_{hard} included in the expression (1) is a coefficient set in advance. L_{hard} included in the expression (1) is a value determined by an expression (3).

$${ℒ}_{hard} = \{ \begin{matrix}f = {( \frac{{ℒ}_{pred}^{′}}{{ℒ}_{pred}} - c )}^{2} & ( f > {d}^{2} ) \\ 0 & ( otherwise )\end{matrix} \qquad ( 3 )$$

L_{pred} included in the expression (3) corresponds to an error between an output result when the “real image I_{s,i}” of the pseudo teacher data is input to the training model as a training target and the “3D human body model X_{s,h,i}” of the pseudo teacher data.

L′_{pred} included in the expression (3) corresponds to an error between an output result when the “synthetic image I′_{s,i}” of the augmented teacher data is input to the training model as a training target and the “3D human body model X′_{s,h,i}” of the augmented teacher data.

In the expression (3), c and d are constants set in advance, and used for adjusting a ratio between L_{pred} and L′_{pred} to fall within a range of c±d.

For example, the information processing device updates the parameters of the first augmenter and the second augmenter in a direction that reduces the total loss Lₜₒₜₐₗ in the expression (1).

As described above, by performing the processing of training the training model, the information processing device can obtain the training model that can correctly recognize the 3D human body model of the person appearing in the image of the Target domain.

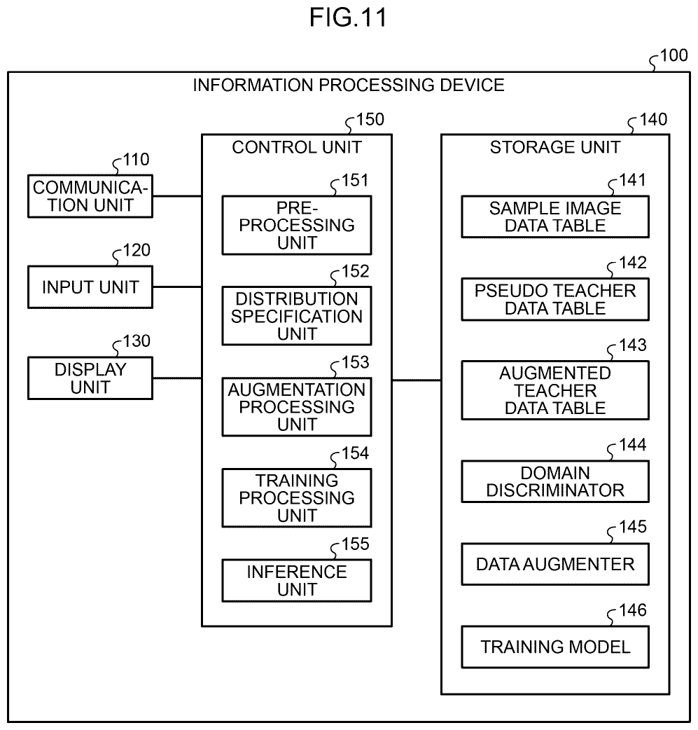

Next, the following describes a configuration example of the information processing device described above. FIG. 11 is a functional block diagram illustrating a configuration of the information processing device according to the present embodiment. As illustrated in FIG. 11, an information processing device 100 according to the present embodiment includes a communication unit 110, an input unit 120, a display unit 130, a storage unit 140, and a control unit 150.

The communication unit 110 performs data communication with an external device via a network. The communication unit 110 is implemented by a Network Interface Card (NIC) and the like.

The input unit 120 is an input device that inputs various pieces of information to the information processing device 100. The input unit 120 corresponds to a keyboard, a mouse, a touch panel, or the like.

The display unit 130 is a display device that displays information output from the control unit 150. The display unit 130 corresponds to a liquid crystal display, an organic Electro Luminescence (EL) display, a touch panel, or the like.

The storage unit 140 includes a sample image data table 141, a pseudo teacher data table 142, an augmented teacher data table 143, a domain discriminator 144, a data augmenter 145, and a training model 146. The storage unit 140 is, for example, implemented by a semiconductor memory element such as a random access memory (RAM) and a flash memory, or a storage device such as a hard disk and an optical disc.

The sample image data table 141 holds a plurality of sample images belonging to the Target domain, which are a plurality of sample images for each scene. For example, the sample images are the sample images 20-1 to 20-4 and 21-1 to 21-3, and the like described above with reference to FIG. 2.

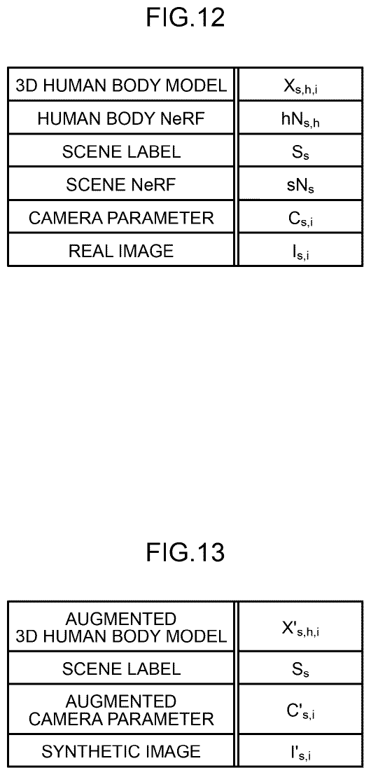

The pseudo teacher data table 142 holds the pieces of pseudo teacher data. FIG. 12 is a diagram illustrating an example of a data structure of the pseudo teacher data. As illustrated in FIG. 12, the pseudo teacher data includes the 3D human body model, the human body NeRF, the scene label, the scene NeRF, the camera parameter, and the real image. The description of the 3D human body model, the human body NeRF, the scene label, the scene NeRF, the camera parameter, and the real image is the same as the description with reference to FIG. 3.

The augmented teacher data table 143 holds the pieces of augmented teacher data. FIG. 13 is a diagram illustrating an example of a data structure of the augmented teacher data. As illustrated in FIG. 13, the augmented teacher data includes the augmented 3D human body model, the scene label, the augmented camera parameter, and the synthetic image. The description of the augmented 3D human body model, the scene label, the augmented camera parameter, and the synthetic image is the same as the above description.

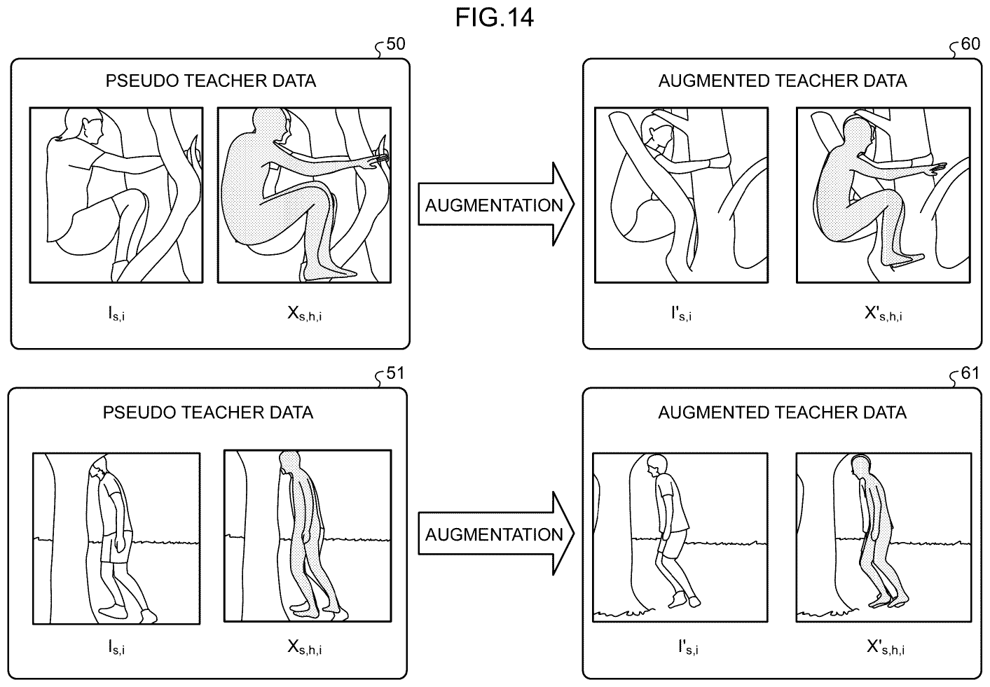

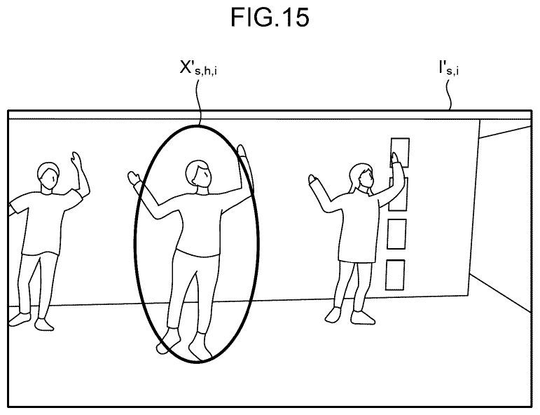

FIG. 14 is a diagram illustrating an example of a relation between the pseudo teacher data and the augmented teacher data. For example, augmented teacher data 60 is generated from pseudo teacher data 50. Augmented teacher data 61 is generated from pseudo teacher data 51. With reference to the pieces of augmented teacher data 60 and 61 generated from the pieces of pseudo teacher data 50 and 51, it can be found that the augmented teacher data of a new posture of the person and new position and orientation of the camera is generated while reflecting external appearance and occlusion of the scene of the Target domain.

The domain discriminator 144 corresponds to the first domain discriminator and the second domain discriminator described above. When the camera parameter is input to the first domain discriminator, a score of likelihood of the Target domain is output from the first domain discriminator. When the 3D human body model is input to the second domain discriminator, a score of likelihood of the Target domain is output from the second domain discriminator.

The data augmenter 145 corresponds to the first augmenter and the second augmenter described above. When the camera parameter is input to the first augmenter, the augmented camera parameter is output. When the 3D human body model is input to the second augmenter, the augmented 3D human body model is output.

The training model 146 is a training model as a training target. For example, the training model 146 is a Neural Network (NN).

The following describes the control unit 150. The control unit 150 includes a preprocessing unit 151, a distribution specification unit 152, an augmentation processing unit 153, a training processing unit 154, and an inference unit 155. The control unit 150 is, for example, implemented by a central processing unit (CPU) or a micro processing unit (MPU). The control unit 150 may also be implemented by an integrated circuit such as an application specific integrated circuit (ASIC) or a field programmable gate array (FPGA), for example.

The preprocessing unit 151 generates the pseudo teacher data based on the sample images included in the sample image data table 141. The preprocessing unit 151 stores the generated pseudo teacher data in the pseudo teacher data table 142. The processing performed by the preprocessing unit 151 corresponds to the “preprocessing” described above.

For example, the preprocessing unit 151 specifies the 3D human body model by inputting the sample image to the HMR. The preprocessing unit 151 generates the human body NeRF and the scene NeRF from the sample images. The preprocessing unit 151 uses information assigned to the sample image as the scene label. The preprocessing unit 151 extracts an edge line, a vanishing point, and the like from the sample image, and estimates the camera parameter from the extracted edge line, vanishing point, and the like.

The preprocessing unit 151 may generate the pseudo teacher data from the sample images using any other conventional technique.

The distribution specification unit 152 specifies the distribution of the positions and orientations of the camera characteristic of the Target domain based on the camera parameters of the pieces of pseudo teacher data stored in the pseudo teacher data table 142. For example, the distribution specification unit 152 inputs the camera parameters C_{s,i} of the pieces of pseudo teacher data to the first domain discriminator to learn the distribution 40a illustrated in FIG. 7.

The distribution specification unit 152 specifies the distribution of the postures of the person (relative positional relation between the camera and the person) characteristic of the Target domain based on the 3D human body models of the pieces of pseudo teacher data stored in the pseudo teacher data table 142. For example, the distribution specification unit 152 inputs the 3D human body models X_{s,h,i} of the pieces of pseudo teacher data to the second domain discriminator to learn the distribution 40b illustrated in FIG. 8.

The processing performed by the distribution specification unit 152 corresponds to the “processing of specifying the distribution characteristic of the Target domain” described above. The distribution specification unit 152 stores information of the trained first domain discriminator and second domain discriminator in the storage unit 140 as the domain discriminator 144.

The augmentation processing unit 153 augments the camera parameter C_{s,i} of the pseudo teacher data in a range included in the distribution 40a illustrated in FIG. 7 and FIG. 9, and generates the augmented camera parameter C′_{s,i}.

For example, the augmentation processing unit 153 generates the augmented camera parameter C′_{s,i} by inputting the camera parameter C_{s,i} to the first augmenter. The augmentation processing unit 153 inputs the augmented camera parameter C′_{s,i} to the first domain discriminator, and calculates a score of Target domain likeness. The information processing device employs the generated “camera parameter C′_{s,i}” as the augmented camera parameter when the score of Target domain likeness is equal to or larger than a threshold.

The augmentation processing unit 153 augments the 3D human body model X_{s,h,i} of the pseudo teacher data in a range included in the distribution 40b illustrated in FIG. 8 and FIG. 10, and generates the augmented 3D human body model X′_{s,h,i}.

For example, the augmentation processing unit 153 generates the augmented 3D human body model X′_{s,h,i} by inputting the 3D human body model X_{s,h,i} to the second augmenter. The augmentation processing unit 153 inputs the augmented 3D human body model X′_{s,h,i} to the second domain discriminator, and calculates the score of Target domain likeness. The information processing device employs the generated “3D human body model X′_{s,h,i}” as the augmented 3D human body model when the score of Target domain likeness is equal to or larger than the threshold.

The augmentation processing unit 153 also generates the “synthetic image I′_{s,i}” based on the “camera parameter C′_{s,i}” and the “3D human body model X′_{s,h,i}” generated by the processing described above. For example, the augmentation processing unit 153 adjusts the posture of the human body NeRF hN_{s,h} based on the “3D human body model X′_{s,h,i}”. The augmentation processing unit 153 generates the “synthetic image I′_{s,i}” by capturing information obtained by synthesizing the adjusted human body NeRF hN_{s,h} and the scene NeRF sNₛ by the camera of the camera parameter C′_{s,i}.

FIG. 15 is a diagram illustrating an example of the synthetic image generated by the augmentation processing unit. For example, the 3D human body model X′_{s,h,i} included in the synthetic image I′_{s,i} is a 3D human body model generated by using the human body NeRF 14a of the person illustrated in FIG. 5. The 3D human body model of another person is similarly generated based on the human body NeRF of the other person. A background scene of the synthetic image I′_{s,i} is generated by the scene NeRF. The camera position (camera parameter) of the synthetic image I′_{s,i} is the “camera parameter C′_{s,i}”.

The augmentation processing unit 153 generates the augmented teacher data including the augmented 3D human body model, the scene label, the augmented camera parameter, and the synthetic image by performing the processing described above. The scene label of the pseudo teacher data is used as the scene label. The augmentation processing unit 153 registers the generated augmented teacher data in the augmented teacher data table 143.

The processing performed by the augmentation processing unit 153 corresponds to the “processing of generating the augmented teacher data” described above. The augmentation processing unit 153 generates the pieces of augmented teacher data by repeatedly performing the processing described above.

The augmentation processing unit 153 may update the parameters of the first augmenter and the second augmenter described above so that the recognition error output from the training model 146 falls within a certain range. For example, the augmentation processing unit 153 updates the parameters of the first augmenter and the second augmenter in a direction that reduces the total loss Lₜₒₜₐₗ in the expression (1). Due to this, the first augmenter augments the input camera parameter in a range of the distribution 40a so that the recognition error output from the training model 146 falls within a certain range. The second augmenter augments the input 3D human body model in a range of the distribution 40b so that the recognition error output from the training model 146 falls within a certain range.

The training processing unit 154 trains the training model 146 based on the pseudo teacher data table 142 and the augmented teacher data table 143. For example, the training processing unit 154 inputs the “real image I_{s,i}” of the pseudo teacher data to the training model 146, and calculates a recognition error between an output of the training model 146 and the “3D human body model X_{s,h,i}” of the pseudo teacher data. The training processing unit 154 updates the parameters of the training model 146 so that the recognition error is reduced based on the error back-propagation method.

The training processing unit 154 inputs the “synthetic image I′_{s,i}” of the augmented teacher data to the training model 146, and calculates a recognition error between an output of the training model 146 and the “3D human body model X′_{s,h,i}” of the augmented teacher data. The training processing unit 154 updates the parameters of the training model so that the recognition error is reduced based on the error back-propagation method.

The inference unit 155 infers a 3D human body model by inputting image data to the pre-trained training model 146. The inference unit 155 may acquire the image data as a target from the input unit 120, or may acquire the image data from an external device via the communication unit 110. The inference unit 155 may output an inference result to the display unit 130 to be displayed, or may transmit information of the inference result to an external device via the communication unit 110.

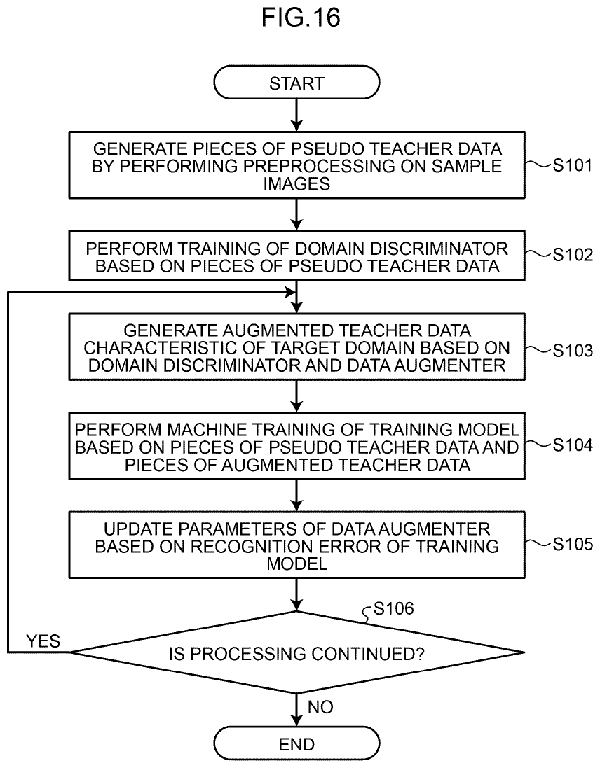

Next, the following describes an example of a processing procedure of the information processing device 100 according to the present embodiment. FIG. 16 is a flowchart illustrating the processing procedure of the information processing device according to the present embodiment. As illustrated in FIG. 16, the preprocessing unit 151 of the information processing device 100 generates the pieces of pseudo teacher data by performing preprocessing on the sample images (Step S101).

The distribution specification unit 152 of the information processing device 100 performs training of the domain discriminator 144 based on the pieces of pseudo teacher data (Step S102). The augmentation processing unit 153 of the information processing device 100 generates the pieces of augmented teacher data characteristic of the target domain based on the domain discriminator 144 and the data augmenter 145 (Step S103).

The training processing unit 154 of the information processing device 100 performs machine training of the training model 146 based on the pieces of pseudo teacher data and the pieces of augmented teacher data (Step S104). The augmentation processing unit 153 updates the parameters of the data augmenter 145 based on the recognition error of the training model 146 (Step S105).

If the processing is continued (Yes at Step S106), the information processing device 100 advances the process to Step S103. On the other hand, if the processing is not continued (No at Step S106), the information processing device ends the processing.

Next, the following describes an effect of the information processing device 100 according to the present embodiment. The information processing device 100 specifies the distribution of the positions and orientations of the camera characteristic of the Target domain and the distribution of the postures of the person characteristic of the Target domain based on the sample images belonging to the Target domain. The information processing device 100 augments the positions and orientations of the camera and the postures of the person to be included in the distribution of the camera positions characteristic of the Target domain and the distribution of the postures of the person characteristic of the Target domain, and generates the augmented teacher data using an augmented result.

For example, as described above with reference to FIG. 1, the information processing device 100 augments the positions and orientations of the camera (camera parameters) to be included in the distribution of the positions and orientations of the camera characteristic of the Target domain. Due to this, with respect to the distribution 10 of the Target domain data, it is possible to cover the range 10a larger than a range that can be covered by the second means described as the conventional technique. That is, it is possible to generate the augmented teacher data for training the training model that can correctly recognize the posture of the person appearing in an image that is captured at a position and orientation of the camera different from the position and orientation of the camera corresponding to the sample image.

The information processing device 100 inputs the “synthetic image I′_{s,i}” of the augmented teacher data to the training model 146, and calculates a recognition error between an output of the training model 146 and the “3D human body model X′_{s,h,i}” of the augmented teacher data. Due to this, it is possible to train the training model that can correctly recognize the posture of the person appearing in an image that is captured at a position and orientation of the camera different from the position and orientation of the camera corresponding to the sample image.

When training the training model 146 based on the pieces of augmented teacher data, the information processing device 100 updates the parameters of the first augmenter and the second augmenter described above so that the recognition error output from the training model 146 falls within a certain range. Due to this, it is possible to generate the augmented teacher data that can reinforce weaknesses of the training model 146 with difficulty appropriate for the training model 146.

The information processing device 100 learns the distribution 40a of the positions and orientations of the camera (camera parameters) characteristic of the Target domain and the distribution 40b indicating the distribution of the postures of the person (3D human body model) based on the pieces of pseudo teacher data. Due to this, it is possible to generate the augmented teacher data characteristic of the Target domain.

The information processing device 100 augments the postures of the person so that a score of likelihood in a case of inputting the augmented postures of the person to a first discriminator is equal to or larger than a threshold. In the information processing device 100, the augmenting the positions and orientations of the camera augments the positions and orientations of the camera so that the score of likelihood in a case of inputting the augmented positions and orientations of the camera to a second discriminator is equal to or larger than the threshold. Due to this, it is possible to efficiently generate the postures of the person (3D human body model) and the positions and orientations of the camera (camera parameter) characteristic of the Target domain.

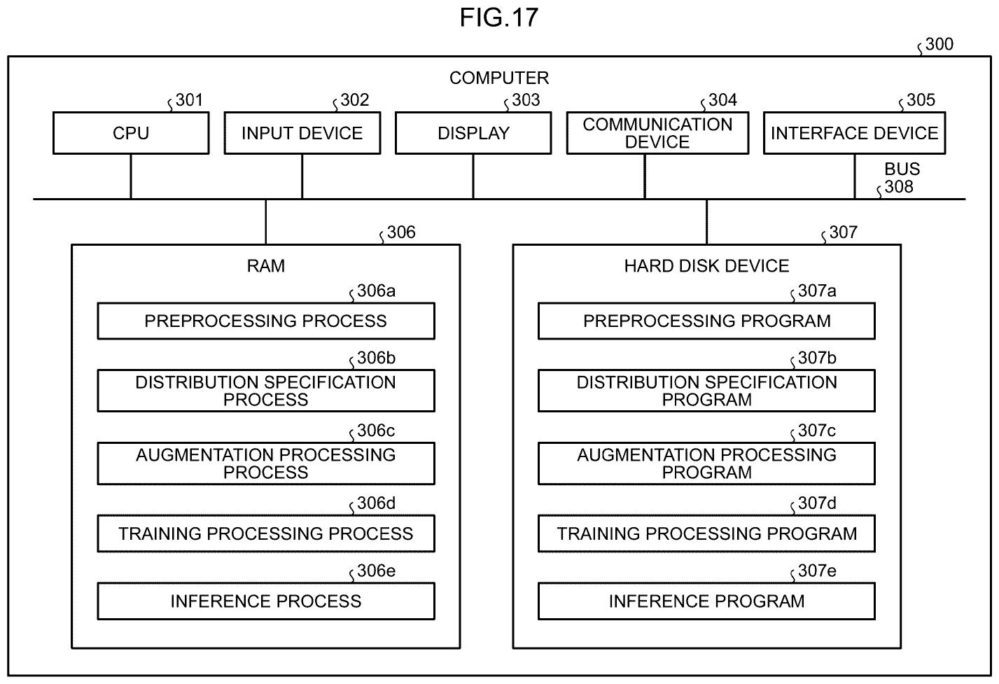

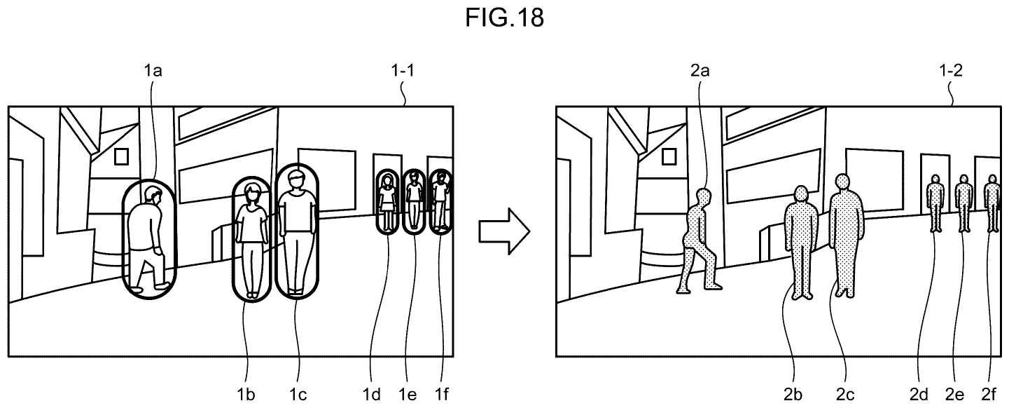

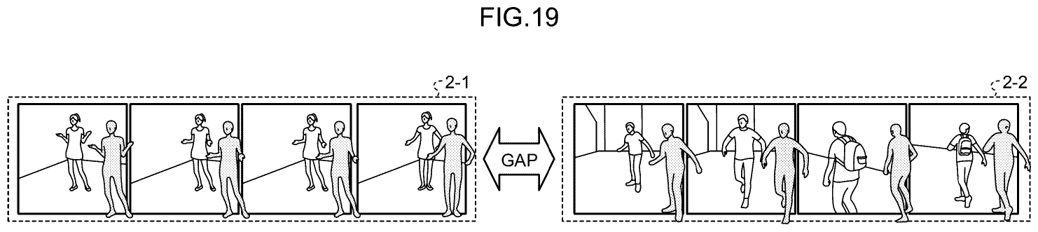

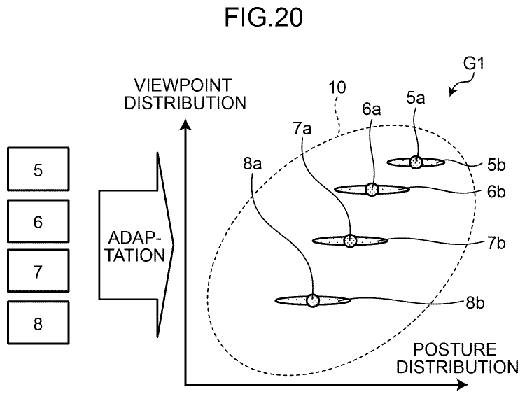

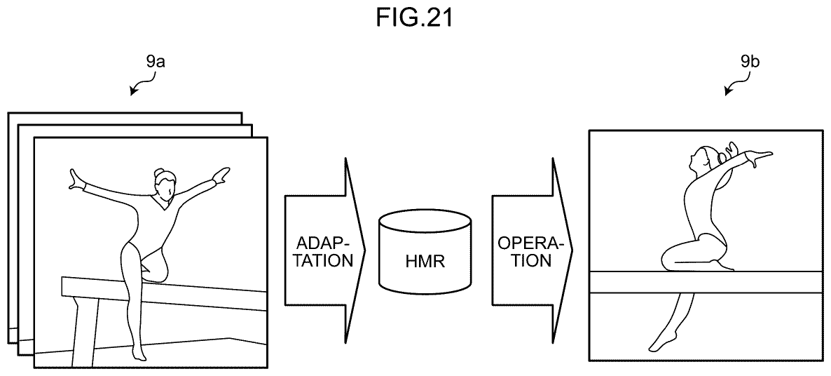

Next, the following describes an example of a hardware configuration of a computer that implements the same function as that of the information processing device 100 described in the above embodiment. FIG. 17 is a diagram illustrating an example of the hardware configuration of the computer that implements the same function as that of the information processing device in the embodiment.

As illustrated in FIG. 17, a computer 300 includes a CPU 301 that performs various kinds of arithmetic processing, an input device 302 that receives data input from a user, and a display 303. The computer 300 also includes a communication device 304 that exchanges data with an external device and the like via a wired or wireless network, and an interface device 305. The computer 300 further includes a RAM 306 that temporarily stores various kinds of information, and a hard disk device 307. The devices 301 to 307 are connected to a bus 308.

The hard disk device 307 includes a preprocessing program 307a, a distribution specification program 307b, an augmentation processing program 307c, a training processing program 307d, and an inference program 307e. The CPU 301 reads out each of the computer programs 307a to 307e to be loaded into the RAM 306.

The preprocessing program 307a functions as a preprocessing process 306a. The distribution specification program 307b functions as a distribution specification process 306b. The augmentation processing program 307c functions as an augmentation processing process 306c. The training processing program 307d functions as a training processing process 306d. The inference program 307e functions as an inference process 306e.

Processing of the preprocessing process 306a corresponds to the processing of the preprocessing unit 151. Processing of the distribution specification process 306b corresponds to the processing of the distribution specification unit 152. Processing of the augmentation processing process 306c corresponds to the processing of the augmentation processing unit 153. Processing of the training processing process 306d corresponds to the processing of the training processing unit 154. Processing of the inference process 306e corresponds to the processing of the inference unit 155.

The computer programs 307a to 307e are not necessarily stored in the hard disk device 307 from the beginning. For example, each computer program is stored in a “portable physical medium” such as a flexible disk (FD), a CD-ROM, a DVD, a magneto-optical disc, or an IC card to be inserted into the computer 300. The computer 300 may then read out and execute each of the computer programs 307a to 307e.

It is possible to generate augmented data for training a machine training model that can correctly recognize a 3D human body model of a person appearing in an image that is captured at a position of a camera different from a position (at least one of a position and orientation) of the camera corresponding to a sample image.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A generation method comprising:
specifying a first distribution of postures of a person and a second distribution of positions or orientations or both of a camera based on a plurality of sample images in which the postures of the person and the positions and orientations of the camera that captures the person are different from each other;
augmenting the postures of the person in a range included in the first distribution;
augmenting the positions or orientations or both of the camera in a range included in the second distribution; and
generating an augmented image based on the augmented positions or orientations or both of the camera and the augmented postures of the person, by using a processor.

2. The generation method according to claim 1, further including inputting the augmented image generated at the generating to a machine training model, and training the machine training model based on a recognition error between an output result of the machine training model and a three-dimensional human body model corresponding to the augmented postures of the person.

3. The generation method according to claim 2, further including augmenting the postures of the person so that the recognition error falls within a certain range, and augmenting the positions or orientations or both of the camera so that the recognition error falls within a certain range.

4. The generation method according to claim 1, further including: training a first discriminator that outputs likelihood that the augmented postures of the person are included in the first distribution based on the postures of the person included in the sample images; and
training a second discriminator that outputs likelihood that the augmented positions or orientations or both of the camera are included in the second distribution based on the positions or orientations or both of the camera included in the sample images.

5. The generation method according to claim 4, further including augmenting the postures of the person so that a score of likelihood in a case of inputting the augmented postures of the person to the first discriminator is equal to or larger than a threshold, and augmenting the positions or orientations or both of the camera so that a score of likelihood in a case of inputting the augmented positions or orientations or both of the camera to the second discriminator is equal to or larger than a threshold.

6. A non-transitory computer-readable recording medium having stored therein a generation program that causes a computer to execute a process comprising:
specifying a first distribution of postures of a person and a second distribution of positions or orientations or both of a camera based on a plurality of sample images in which the postures of the person and the positions and orientations of the camera that captures the person are different from each other;
augmenting the postures of the person in a range included in the first distribution;
augmenting the positions or orientations or both of the camera in a range included in the second distribution; and
generating an augmented image based on the augmented positions or orientations or both of the camera and the augmented postures of the person.

7. The non-transitory computer-readable recording medium according to claim 6 wherein the process further includes inputting the augmented image generated at the generating to a machine training model, and training the machine training model based on a recognition error between an output result of the machine training model and a three-dimensional human body model corresponding to the augmented postures of the person.

8. The non-transitory computer-readable recording medium according to claim 7 wherein the process further includes augmenting the postures of the person so that the recognition error falls within a certain range, and augmenting the positions of the camera so that the recognition error falls within a certain range.

9. The non-transitory computer-readable recording medium according to claim 6 wherein the process further includes training a first discriminator that outputs likelihood that the augmented postures of the person are included in the first distribution based on the postures of the person included in the sample images; and
training a second discriminator that outputs likelihood that the augmented positions or orientations or both of the camera are included in the second distribution based on the positions or orientations or both of the camera included in the sample images.

10. The non-transitory computer-readable recording medium according to claim 9 wherein the process further includes augmenting the postures of the person so that a score of likelihood in a case of inputting the augmented postures of the person to the first discriminator is equal to or larger than a threshold, and augmenting the positions or orientations or both of the camera so that a score of likelihood in a case of inputting the augmented positions or orientations or both of the camera to the second discriminator is equal to or larger than a threshold.

11. An information processing device comprising:
a memory; and
a processor coupled to the memory and configured to:
specify a first distribution of postures of a person and a second distribution of positions or orientations or both of a camera based on a plurality of sample images in which the postures of the person and the positions and orientations of the camera that captures the person are different from each other;
augment the postures of the person in a range included in the first distribution;
augment the positions or orientations or both of the camera in a range included in the second distribution; and
generate an augmented image based on the augmented positions or orientations or both of the camera and the augmented postures of the person.

12. The information processing device according to claim 11, wherein the processor is further configured to input the augmented image generated at the generating to a machine training model, and train the machine training model based on a recognition error between an output result of the machine training model and a three-dimensional human body model corresponding to the augmented postures of the person.

13. The information processing device according to claim 12, wherein the processor is further configured to augment the postures of the person so that the recognition error falls within a certain range, and augment the positions or orientations or both of the camera so that the recognition error falls within a certain range.

14. The information processing device according to claim 11, wherein processor is further configured to train a first discriminator that outputs likelihood that the augmented postures of the person are included in the first distribution based on the postures of the person included in the sample images; and
train a second discriminator that outputs likelihood that the augmented positions or orientations or both of the camera are included in the second distribution based on the positions or orientations or both of the camera included in the sample images.

15. The information processing device according to claim 14, wherein the processor is further configured to augment the postures of the person so that a score of likelihood in a case of inputting the augmented postures of the person to the first discriminator is equal to or larger than a threshold, and augment the positions or orientations or both of the camera so that a score of likelihood in a case of inputting the augmented positions or orientations or both of the camera to the second discriminator is equal to or larger than a threshold.
